(19) United States
(12) Patent Application Publication
(10) Pub. No.: US 2018/0216607 A1
(43) Pub. Date: Aug. 2, 2018

(54) Load Shedding Control System for Pumps

(71) Applicant: Baker Hughes, a GE Company, LLC, Houston, TX (US)

(72) Inventors: Lloyd John Collins, Brisbane (AU); Hamid Zarei, Brisbane (AU)

(21) Appl. No.: 15/881,533

(22) Filed: Jan. 26, 2018

Related U.S. Application Data
(60) Provisional application No. 62/451,067, filed on Jan. 27, 2017.

(51) Int. Cl. F04B 17/05; F04B 49/10; F04B 49/06; F02M 35/10; F02B 63/06

(52) U.S. Cl. CPC F04B 17/05; F04B 49/10; F02B 63/06; F02M 35/1038; F04B 49/06

(57) ABSTRACT

A method for controlling a pumping system includes a pump, a pump motor, a generator that provides power to the pump motor and an engine that drives the generator. The method includes the steps of operating the pump at a first operational speed, detecting a transient high load event, reducing the speed of the pump to a second operational speed, detecting the end of the transient high load event, and increasing the speed of the pump to the first operational speed.

### RELATED APPLICATIONS

This application claims the benefit of U.S. Provisional Patent Application No. 62/451,067 filed Jan. 27, 2017 entitled, “Load Shedding Control System for Pumps,” the disclosure of which is herein incorporated by reference.

### FIELD OF THE INVENTION

This invention relates generally to pumps used in the oilfield, and more particularly, but not by way of limitation, to a control system for preventing a generator engine from stalling when the oilfield pump is subjected to unexpected loads.

### BACKGROUND

Pumps are often used to evacuate fluids from a subterranean wellbore. Positive displacement pumps may be driven by a rotating or reciprocating rod string that extends down the wellbore to the pump from a motor located on the surface. Progressing cavity pumps (PCPs) can be driven by a rotating drive head located about the well. Reciprocating pumps can be driven by a surface-mounted pump jack that includes a walking beam that pivots back and forth atop a Samson post. Pitman and crank arms convert the rotational motion of the pump jack motor into reciprocating, vertical movement.

In each case, the motor used in the rotating drive head or the pump jack may be electric or hydraulic. A generator set may be used to provide a source of pressurized hydraulic fluid or electrical power to the motor. The generator set typically includes an internal combustion engine that drives an electrical generator or a hydraulic pump. The engine of generator set is configured to operate at a relatively constant speed and load. However, the operational parameters of the generator set are typically at least partially dependent on the load realized by the pumping unit. A transient increased load on the pumping unit will be passed along the generator set. For example, if the downhole pump encounters a slug of highly viscous fluid or fluid with a significant volume of entrained solids, the generator set may be incapable of satisfying the increased load realized by the pump motor. This may cause the engine on the generator set to stall. If the engine stalls, the pump unit will go offline until the generator set can be restarted.

In the past, pump manufacturers have addressed the potential for generator engine stalling by calculating the maximum expected pump flow and force required to lift the fluid to the surface. An estimated power demand is then calculated and an engine package is selected to meet the power demand. Pump manufacturers have adopted a practice of oversizing the engine and generator to reduce the risk of engine stalling.

Although generally effective, the practice of oversizing the generator set adds significant cost to the pumping unit and may also reduce the efficiency of the operation. There is, therefore, a need for an improved pumping unit that overcomes these and other deficiencies in the prior art.

### SUMMARY OF THE INVENTION

In one aspect, the present invention provides a method for controlling a pumping system that includes a pump, a pump motor, a generator that provides power to the pump motor, and an engine that drives the generator. The method includes the steps of operating the pump at a first operational speed, detecting a transient high load event, reducing the speed of the pump to a second operational speed, detecting the end of the transient high load event, and increasing the speed of the pump to the first operational speed.

### BRIEF DESCRIPTION OF THE DRAWINGS

FIG. 1 is a side view of a pumping system constructed in accordance with an exemplary embodiment that includes a progressing cavity pump.

FIG. 2 is a side view of a pumping system constructed in accordance with an exemplary embodiment that includes a reciprocating pump.

FIG. 3 is a flow chart for a pump operational control routine utilizing a load shedding control scheme.

### WRITTEN DESCRIPTION

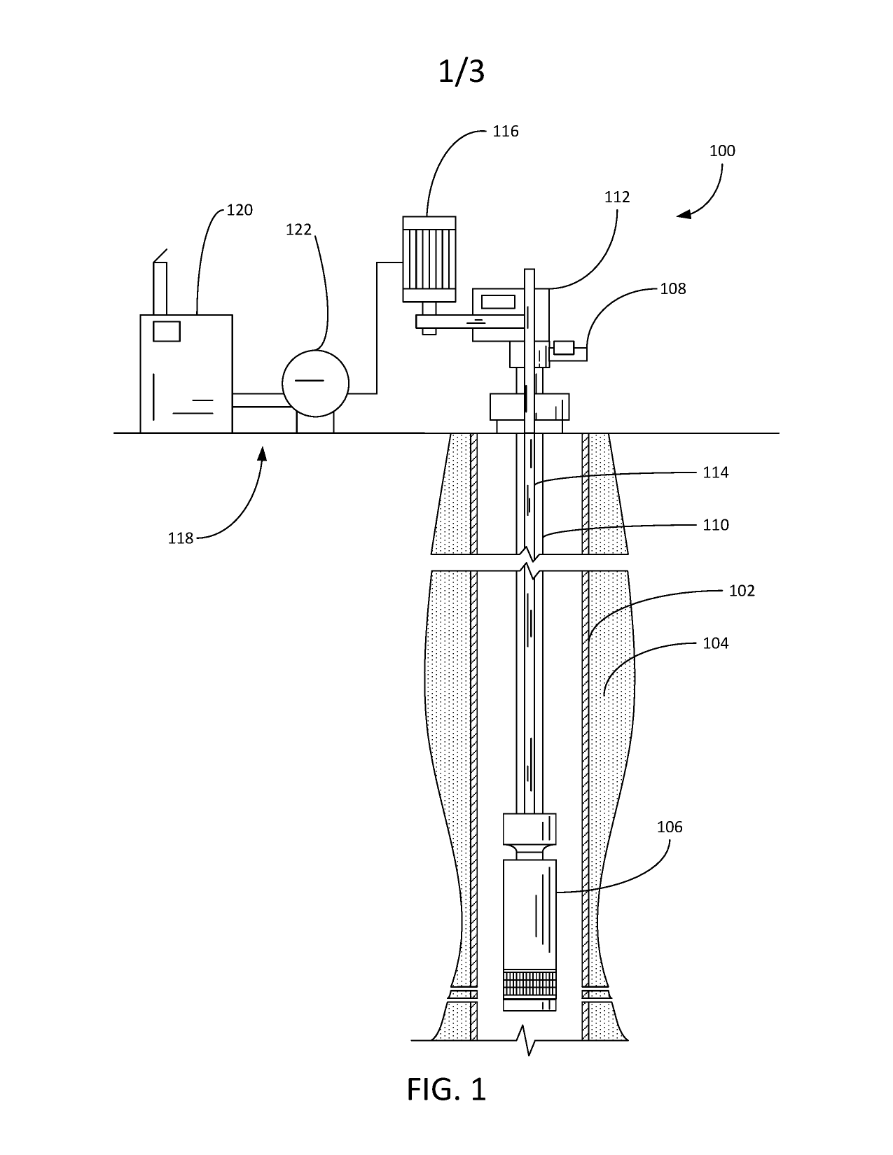

FIG. 1 shows a pumping system 100 configured to evacuate fluids from a wellbore 102. The wellbore 102 is drilled in a geologic formation 104 that produces hydrocarbons, water or other fluids. In FIG. 1, the pumping system 100 includes a progressing cavity pump 106 that is connected to a wellhead 108 by production tubing 110. A drive assembly 112 mounted above the wellhead 108 rotates a rod string 114 that extends through the production tubing 110 to rotate the progressing cavity pump 106. The drive assembly 112 is driven by a hydraulic or electric PCP motor 116.

The PCP motor 116 is powered by a generator set 118. The generator set 118 includes an engine 120 and a generator 122. If the PCP motor 116 is a hydraulic motor, the generator 122 is a hydraulic pump that provides a source of pressurized hydraulic fluid to the PCP motor 116. If the PCP motor 116 is an electric motor, the generator 122 is an electrical generator that provides a source of electrical power to the PCP motor 116. In either case, the engine 120 is an internal combustion engine that is connected to an independent fuel source (not shown) or configured to receive a source of combustible fuel directly from the wellbore 102. It will be appreciated that the generator set 118 can be contained within a housing to protect the generator set 118 from the elements.

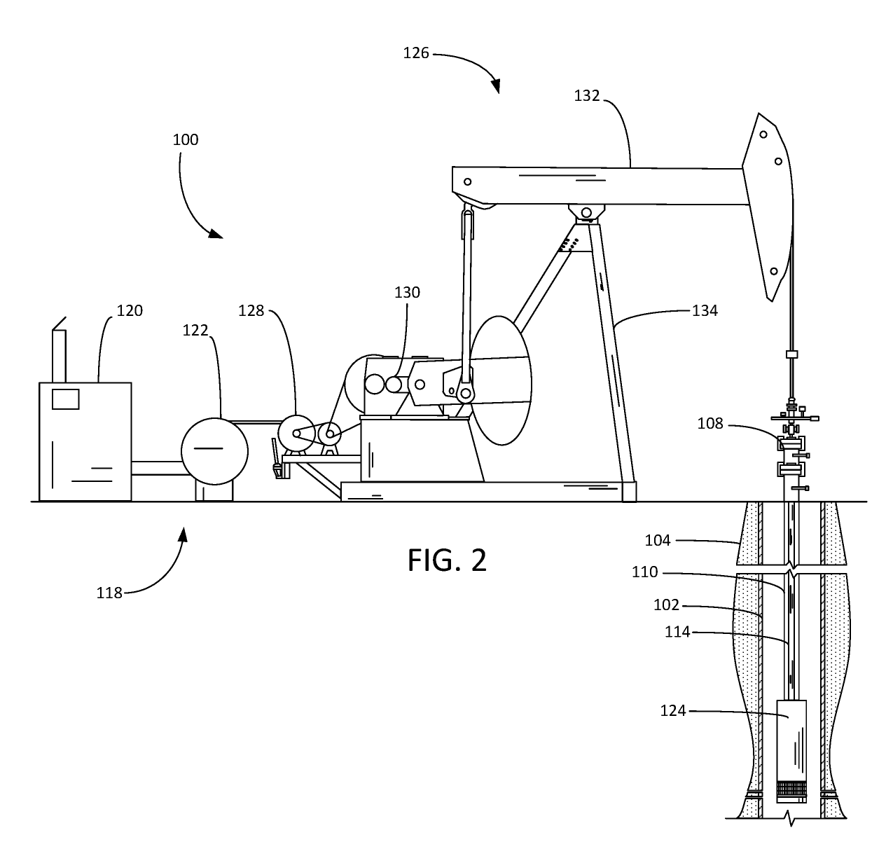

Turning to FIG. 2, shown therein is a side view of the pumping system 100 constructed in accordance with a second embodiment. In the embodiment depicted in FIG. 2, the pumping system 100 includes a reciprocating pump 124 driven by a beam pump jack 126. The pump jack 126 is driven by an electric or hydraulic pump jack motor 128. The rotational power output from the pump jack motor 128 is carried through a gearbox to a crankshaft 130. A walking beam 132 is pivotally supported by a Samson post 134. One end of the walking beam 132 is connected through pitman and crank arms to the crankshaft 130. The opposite end of the walking beam 132 is connected to the rod string 114. As the crankshaft 130 rotates, the walking beam 132 rocks up and down on the Sampson post 134, thereby raising and lowering the rod string 114 to operate the reciprocating pump 124. In a reciprocating cycle of the pump jack 126, well fluids are lifted within the production tubing 110 during the upstroke of the rod string 114.

The pump jack motor 128 is powered by the generator set 118. If the pump jack motor 128 is a hydraulic motor, the generator 122 is a hydraulic pump that provides a source of pressurized hydraulic fluid to the pump jack motor 128. If the pump jack motor 128 is an electric motor, the generator 122 is an electrical generator that provides a source of electrical power to the pump jack motor 128. As discussed above, the engine 120 is an internal combustion engine that is connected to an independent fuel source (not shown) or configured to receive a source of combustible fuel directly from the wellbore 102.

As used in this disclosure, the term “pumping system” refers to the progressing cavity pump 106 system illustrated in FIG. 1, the reciprocating pump 124 system illustrated in FIG. 2, and other positive displacement pumping systems that include a motor that is provided power by a generator set. In each case, the performance of the pumping system 100 is subject to fluctuations in the composition of the fluid being evacuated from the wellbore 102. If the reciprocating pump 124 or progressing cavity pump 106 encounters a slug of highly viscous fluid or a volume of fluid that includes a significant portion of entrained solids, the PCP motor 116 or pump jack motor 128 may require additional power from the generator set 118.

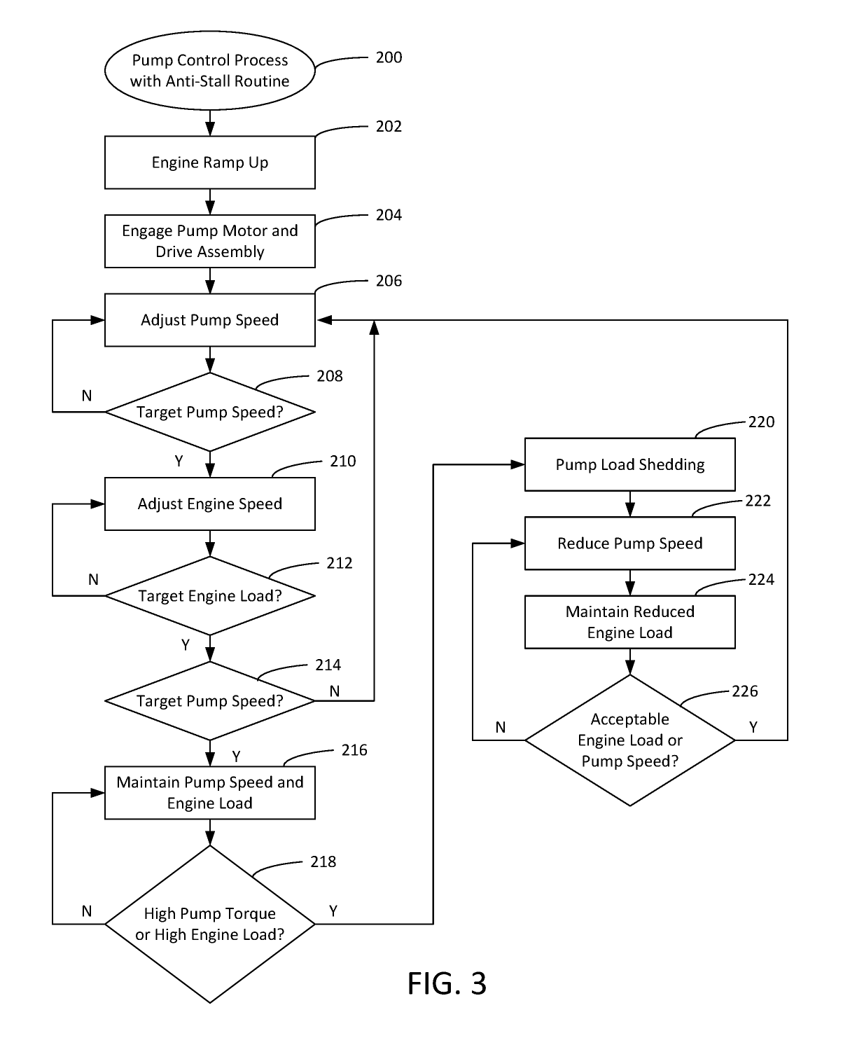

To prevent the engine 120 in the generator set 118 from stalling under the increased load, the pumping system 100 is programmed to follow a pump control process with anti-stall routine 200 depicted in FIG. 3. It will be appreciated that the process 200 can be incorporated into the pumping system 100 or in a separate motor control unit. As used with reference to the process outlined in FIG. 3, the term “pump” will broadly refer to the reciprocating pump 124 and the progressing cavity pump 106. Similarly, the term “pump motor” will broadly to both the pump jack motor 128 and the PCP motor 116.

The pump control process with anti-stall routine 200 begins at step 202, when the engine 120 of the generator set 118 is started and ramped up to a preset operating speed. Once the engine 120 reaches the desired operating speed, the pumping system 100 can be engaged at step 204. At this step, the pump motor is activated. The drive assembly 112 rotates the rod string 114 to turn the progressing cavity pump 106 and the crankshaft 130 and walking beam 132 cooperate to raise and lower the reciprocating pump 124. At step 206, the speed of the pump is adjusted and at decision step 208, the speed of the pump is compared against the set point. The process 200 follows a loop between steps 206 and 208 until the pump reaches the desired operational speed.

Next, at step 210, the speed of the engine 120 is reduced while attempting to maintain the desired operational speed of the pump. Reducing the speed of the engine 120 improves the efficiency of the pumping system 100. At step 212, the process determines whether the engine 120 is operating within the desired load range. The process follows a loop between steps 210 and 212 to optimize the load on the engine 120. In some embodiments, the process 200 is configured to operate the engine 120 at between 20% and 70% of load capacity, with a target engine load of about 6500%.

At step 214, the process 200 checks the speed of the pump against the desired set-point. If necessary, the process returns to step 206 to adjust the operational speed of the pump. A loop is thus created between steps 206 and 214 to maintain the desired speed of the pump while the rotational speed of the engine 120 is reduced to an optimal loading level.

The pump and engine 120 are operated at the optimal speeds and loads at step 216. An evaluation step 218 determines if the pump and engine are operating within normal loads. If so, the pump continues to operate within the prescribed parameters. If, however, the pump encounters a high-torque condition or the engine encounters a high-load condition that increases the load on the engine 120 beyond acceptable limits, the process 200 moves to step 220 to initiate the anti-stall, load shedding routine.

In exemplary embodiments, the load shedding routine is initiated by observing a load on the engine 120 that exceeds about 70% of design capacity. The load on the engine 120 can be determined by measuring the intake manifold pressure at the engine 120 or by comparing the instantaneous actual engine speed against the target engine speed. Monitoring the engine load provides a mechanism for rapidly detecting a transient high load event.

Once the load shedding routine is initiated, the speed of the pump is reduced to a preset value at step 222. In exemplary embodiments, the speed of the progressing cavity pump 106 or reciprocating pump 124 is reduced by about 60%. Reducing the speed of the progressing cavity pump 106 reduces the load on the PCP motor 116 and generator set 118 by allowing the progressing cavity pump 106 to process the solids or highly viscous fluid more slowly. Similarly, reducing the operation speed of the reciprocating pump 124 reduces the load on the pump jack motor 128 and the engine 120.

At step 224, the pump is operated at the reduced speed for a calculated period before the load on the engine 120 and pump speed are reevaluated at step 226. In an exemplary embodiment, the load on the engine 120 is deemed to be within acceptable limits if the load is less than about 70% of capacity and the pump speed is regarded as acceptable if it meets the desired target pump speed established at step 208. If at step 226 the load on the engine 120 or pump speed are not acceptable or are inconsistent over a preset sample period, the process 200 returns to step 224 and the speed of the pump is further reduced to shed more of the load from the pumping system 100.

Following the initial iteration through the load shedding routine 220, the speed of the pump may be reduced by incrementally smaller amounts as the process passes within the loop created by steps 222, 224 and 226. In some embodiments, it is desirable to delay or slow the iterative process within the load shedding routine 220. For example, the engine load evaluation step 226 can be performed on a periodic basis to allow the system to stabilize between adjustments to the rotational speed of the progressing cavity pump 106. Similarly, when the process 200 is applied to the reciprocating pump 124 and pump jack 126, it is necessary to coordinate the timing of the load evaluation step 226 and pump speed reduction step 222 to account for the cyclical nature of the loads realized by the pump jack 126. For that application, it is helpful for the engine load evaluation step 226 to occur when the reciprocating pump 124 reaches the point of its cycle that produces the most load on the pump jack motor 128 and engine 120.

If at step 226 the load on the engine 120 is determined to fall within acceptable limits signaling the end of the transient high load event, the process returns to step 206 and the speed of the pump is slowly increased. The process 200 then moves through the series of control loops that cause the pump to operate at the desired speed with the engine 120 operating at an optimal efficiency, while constantly monitoring the engine load for any additional transient high load events.

In this way, the process 200 includes a pump control method that includes a stall-mitigation routine. In one aspect, the process 200 causes the pump to operate within a desired speed range, while reducing the load on the engine 120 to an optimal level. At the same time, the process 200 prevents the engine 120 from stalling by responding to excessive engine loads by rapidly decelerating the operating speed of the pump. This control scheme presents a significant advantage over the prior art by reducing the risk of engine stalling and making possible the use of smaller engines 120.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention. cm What is claimed is:

1. A method for controlling a pumping system that includes a pump, a pump motor, a generator that provides power to the pump motor and an engine that drives the generator, the method comprising the steps of:
operating the pump at a first operational speed;
detecting a transient high load event;
reducing the speed of the pump to a second operational speed;
detecting the end of the transient high load event; and
increasing the speed of the pump to the first operational speed.

2. The method of claim 1, wherein the step of operating the pump at a first operational speed comprises rotating a progressing cavity pump at the first operational speed.

3. The method of claim 1, wherein the step of operating the pump at a first operational speed comprises raising and lowering a reciprocating pump at the first operational speed.

4. The method of claim 1, wherein the step of detecting a transient high load event further comprises measuring a change in the intake manifold pressure of the engine.

5. The method of claim 4, wherein the step of detecting a transient high load event further comprises detecting a load on the engine that exceeds about 70% of the capacity of the engine.

6. The method of claim 1, wherein the step of reducing the speed of the pump to a second operational speed comprises reducing the speed of the pump to a second operational speed that is about 60% of the first operational speed.

7. The method of claim 1, wherein the step of detecting the end of the transient high load event further comprises detecting a load on the engine that is less than about 70% of the capacity of the engine.

8. The method of claim 1, further comprising a step of operating the pump at the second operational speed during the transient high load event.

9. A method for controlling a submersible progressing cavity pump, the method comprising the steps of:
connecting the submersible progressing cavity pump to a surface-mounted drive assembly with a rotatable polished rod, wherein the drive assembly includes a pump motor;
connecting the pump motor to a generator;
connecting the generator to an engine configured to drive the generator;
activating the engine, generator and pump motor to rotate the submersible progressing cavity pump at a first operational speed;
detecting a transient high load event;
reducing the rotational speed of the submersible progressing cavity pump to a second operational speed;
detecting the end of the transient high load event; and
increasing the rotational speed of the submersible progressing cavity pump to the first operational speed.

10. The method of claim 9, wherein the step of detecting a transient high load event further comprises measuring a change in the intake manifold pressure of the engine.

11. The method of claim 10, wherein the step of detecting a transient high load event further comprises detecting a load on the engine that exceeds about 70% of the capacity of the engine.

12. The method of claim 9, wherein the step of reducing the rotational speed of the progressing cavity pump to a second operational speed comprises reducing the rotational speed of the progressing cavity pump to a second operational speed that is about 60% of the first operational speed.

13. The method of claim 9, wherein the step of detecting the end of the transient high load event further comprises detecting a load on the engine that is less than about 70% of the capacity of the engine.

14. The method of claim 9, wherein the step of connecting the pump motor to a generator further comprises the connecting the pump motor to a hydraulic generator that provides a source of pressurized hydraulic fluid to the pump motor.

15. A method for controlling a reciprocating pump, the method comprising the steps of:
connecting the reciprocating pump to a pump jack motor;
connecting the pump jack motor to a generator;
connecting the generator to an engine configured to drive the generator;
activating the engine, generator and pump jack motor to cause the reciprocating pump to reciprocate at a first operational speed;
detecting a transient high load event;
reducing the operational speed of the reciprocating pump to a second operational speed;
detecting the end of the transient high load event; and
increasing the operational speed of the reciprocating pump to the first operational speed.

16. The method of claim 15, wherein the step of detecting a transient high load event further comprises measuring a change in the intake manifold pressure of the engine.

17. The method of claim 16, wherein the step of detecting a transient high load event further comprises detecting a load on the engine that exceeds about 70% of the capacity of the engine.

18. The method of claim 15, wherein the step of reducing the speed of the pump to a second operational speed comprises reducing the speed of the pump to a second operational speed that is about 60% of the first operational speed.

19. The method of claim 15, wherein the step of detecting the end of the transient high load event further comprises detecting a load on the engine that is less than about 70% of the capacity of the engine.

20. The method of claim 15, further comprising a step of operating the pump at the second operational speed during the transient high load event.
